(19) United States
(12) Patent Application Publication
(10) Pub. No.: US 2017/0117760 A1
(43) Pub. Date: Apr. 27, 2017

(54) ROTATING ELECTRICAL MACHINE WITH FLUX CHOKING FEATURES

(71) Applicant: ElectroCraft, lnc., Dover, NH (US)

(72) Inventors: David Greenlaw, Merrimack, NH (US); Malmalabaduge Thilina Fernando, Dover, NH (US)

(21) Appl. No.: 15/334,352

(22) Filed: Oct. 26, 2016

Related U.S. Application Data
(60) Provisional application No. 62/246,717, filed on Oct. 27, 2015.

(51) Int. Cl. H02K 1/14; H02K 1/02; H02K 5/04; H02K 1/27; H02K 1/26

(52) U.S. Cl. CPC H02K 1/146; H02K 1/2706; H02K 1/26; H02K 5/04; H02K 1/02; H02K 2213/03

(57) ABSTRACT

An electrical machine, such as a dynamoelectric machine, includes a stator with teeth that define slots between the teeth to accommodate electrically conductive windings and a rotor inside the stator. The rotor has alternating polarity magnetic poles. The magnetic poles at the rotor outnumber the slots at the stator. The machine includes flux choking features, each of which extends along a circumferential path between one pair of adjacent teeth on the stator at an inner edge of the stator.

### CROSS-REFERENCE TO RELATED APPLICATION(S)

This application claims the benefit of priority to U.S. Provisional Patent Application No. 62/246,717, entitled, ROTATING ELECTRIC MACHINE WITH FLUX CHOKING FEATURES, which was filed on Oct. 27, 2015. The disclosure of the prior application is incorporated by reference herein in its entirety.

### FIELD OF THE INVENTION

This disclosure relates to a rotating electrical machine and, more particularly, refers to a rotating electrical machine with flux choking features.

### BACKGROUND

Rotating electrical machines, such as motors or the like are ubiquitous in modern life.

Torque density is a measure of the torque-producing/generating capability relative to its size of a rotating electrical machine. It can be thought of as the ratio of torque produced to volume and is expressed in units of torque (e.g., Newton-meters) per volume (e.g., cubic meters).

In certain applications, machines having high torque density are desirable.

### SUMMARY OF THE INVENTION

In one aspect, a machine, such as a dynamoelectric machine, includes a stator with teeth that define slots between the teeth to accommodate windings and a rotor inside the stator. The rotor has alternating polarity magnetic poles. The poles at the rotor outnumber the slots at the stator. The machine includes flux choking features, each of which extends along a circumferential path between one pair of adjacent teeth on the stator at an inner edge of the stator.

In another aspect, a method is of enhancing torque density in a machine, such as a dynamoelectric machine is disclosed. The dynamoelectric machine includes a stator with teeth that define slots between the teeth to accommodate windings, and a rotor inside the stator with alternating polarity magnetic poles, where the poles at the rotor outnumber the slots at the stator.

In a typical implementation, the method includes providing a plurality of flux choking features in the machine. Each flux choking feature extends circumferentially between one pair of adjacent teeth on the stator at an inner edge of the stator.

The flux choking feature is generally configured to prevent magnetic flux from the magnets from bypassing the teeth of the stator during machine operation.

The flux choking feature can be characterized generally by the following equation:

$$d = \frac{0.25 f [ a - b ]}{[ g + h ]} [ \frac{Brh}{B} - \frac{L}{{μ}_{R}} ] ,$$

where:
d=the maximum thickness of the flux choking feature in a radial direction,
g=the thickness of an air gap between the rotor and the stator,
h=the thickness of one of the magnets in a radial direction,
L=the length of the flux choking feature circumferentially,
f=the diameter of the rotor,
a=the slot angle=360 degrees/a number of slots (N),
b=the pole angle=360 degrees/a number of poles (M),
μᵣ=the relative permeability value of the stator's lamination material at a saturation flux density,
B=the saturation flux density inside the flux choking feature, and
Br=the remanence flux density of each magnet.

In some implementations, one or more of the following advantages are present.

For example, the features and techniques disclosed herein may facilitate creating a machine (e.g., a dynamoelectric machine) that can produce a very high torque density, typically in the range of at least 0.00008 mNm/mm̂3 per mm of stack length in the machine. Stack length refers to the length of the stacked laminations that form the stator and/or rotor. Moreover, these features and techniques disclosed herein are particularly well suited to apply in connection with smaller machines (e.g., motors having an outer housing with a diameter in the range of 15 to 44 millimeters).

Other features and advantages will be apparent from the description and drawings, and from the claims.

### BRIEF DESCRIPTION OF THE DRAWINGS

FIG. 1 is a partial, cross-sectional view of an exemplary implementation of an electrical machine.

FIG. 2 is a perspective view showing an exemplary implementation of pieces that may be used to form part of a stator, such as the stator of the electrical machine in FIG. 1.

FIG. 3 is a perspective view showing an exemplary implementation of pieces that may be used to form part of a stator, such as the stator of the electrical machine in FIG. 1.

FIG. 4 is a perspective view of a partially assembled stator, such as the stator of the electrical machine in FIG. 1.

FIG. 5 is a schematic, cross-sectional view of an exemplary implementation of another electrical machine.

FIG. 6A is a partial, cross-sectional view of an exemplary implementation of an electrical machine.

FIG. 6B is a topographical-style drawing showing magnetic flux distribution in the electrical machine of FIG. 6A when it is operating.

FIG. 7 is a topographical-style drawing showing magnetic flux distribution in an electrical machine similar to electric machine in FIG. 1 when it is operating.

Like reference numerals refer to like elements.

### DETAILED DESCRIPTION

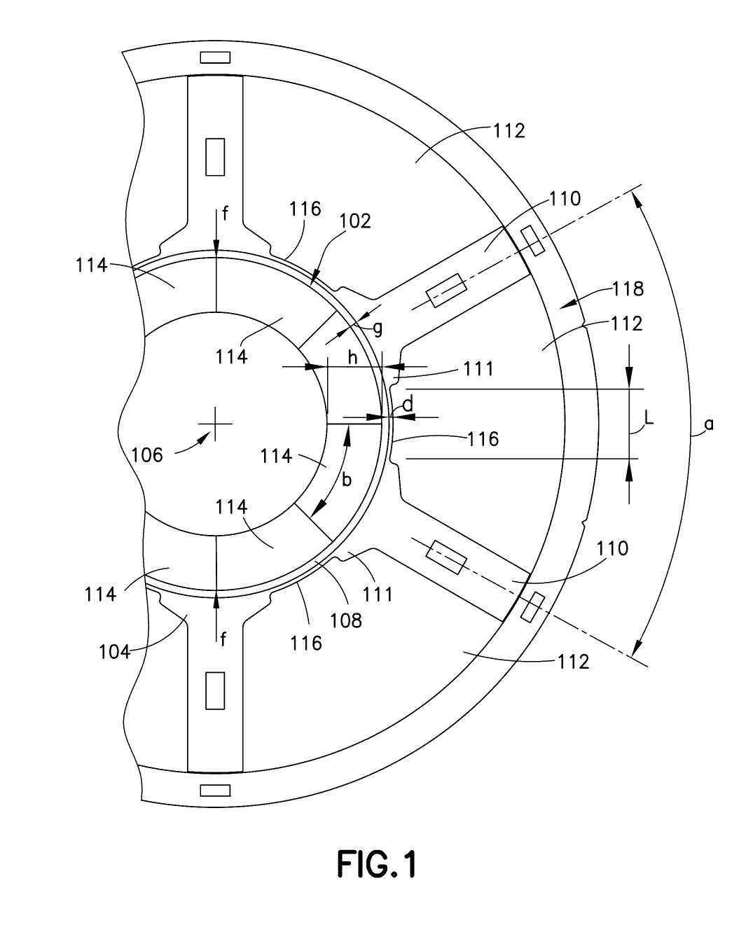

FIG. 1 shows an exemplary implementation of an electrical machine 100 that has a rotor 102 and a stator 104.

The rotor 102 is configured to rotate about an axis 106 when the electrical machine 100 is operating and the stator 104 is configured to remain stationary when the electrical machine 100 is operating. There is an annular air gap 108 between the rotor 102 and the stator 104. In a typical implementation, if the rotor 102 is substantially centered within the stator, which is typical, then the annular air gap 108 is substantially consistent around the entire perimeter of the rotor 102.

In a typical implementation, the electrical machine is configured to operate as a dynamoelectric motor or generator.

The stator 104 has multiple teeth 110 arranged at substantially equal intervals around the circumference of the machine 100. Each tooth 110 extends in a substantially radial direction. There is a slot 112 between each respective pair of adjacent teeth 110. Each slot 112 is configured to accommodate electrically conductive windings (not shown) that wind around the teeth 110. Though only a partial cross-section of the machine 100 is shown in the illustrated implementation, it is clear that the stator 104 represented in the partial cross-section would have six, equally-spaced teeth 110 and, likewise, six slots 112. Each tooth 110 in the illustrated implementation extends between an inner end of the stator 104 and an outer end of the stator 104 in a substantially radial direction. All of the slots 112 in the illustrated implementation are substantially the same size.

The rotor 102 is inside, and surrounded by, the stator 104. The rotor 102, in the illustrated implementation, has multiple magnetic poles 114 arranged about its perimeter. The magnetic poles 114 are arranged in an alternating polarity fashion so that each magnetic pole presents a different polarity than the magnetic pole next to (closest to) it.

The magnetic structure of the rotor 102 can take on any one of a number of different configurations. For example, in a typical implementation, the rotor 102 has a single cylindrical magnet with multiple (e.g., eight) poles. In other implementations, the rotor 102 has multiple (e.g., eight) discrete magnets.

In the illustrated implementation, the rotor 102 represented in the partial cross-section would have eight poles 114. Moreover, in the illustrated implementation, it is clear that each pole 114 is substantially the same size and shape as the other poles 114 in the rotor 102. Thus, each pole has the same, or substantially the same, pole angle (e.g., identified, for example, by “b” in the illustrated figure).

As mentioned above, in the illustrated implementation, the stator 104 has six slots 112 and the rotor 102 has eight poles. It is clear, therefore, that the poles of the rotor 102 outnumber the slots of the stator 104. In theory, increasing the number of poles in a rotor of a rotating electrical machine tends to increase the torque density that the rotating electrical machine can deliver. Often, especially in larger motors, a high number of poles at the rotor is accompanied by a higher number of slots at the stator. However, in very small machines (e.g., ones that have a housing with an outer diameter of 15 to 44 millimeters), increasing the number of slots in the stator of a rotating electrical machine can be difficult to manufacture, and lead to a reduction in the useful application of magnetic flux in the machine, with a corresponding reduction in overall machine efficiency/performance. In a typical implementation, the slot to pole ratio is less than or equal to 0.83.

To help counteract this potentially deleterious effect, the machine 100 in the illustrated implementation has flux choking features 116, each of which forms part of the stator 104 and extends along a substantially circumferential path between an inner end of one tooth 110 and an inner end of an adjacent tooth 110 on the stator 104 at an inner edge of the stator. More particularly, in the illustrated implementation, each tooth 110 has a flared portion 111 at inner edge thereof and each flux choking feature 116 extends from an inner edge of the flared portion 111 of one tooth 110 to an inner edge of the flared portion 111 of another, adjacent tooth 110.

In general, each flux choking feature 116 is configured to prevent magnetic flux from the magnets 114 from bypassing the corresponding tooth 110 of the stator 104 during operation of the machine 100.

In the illustrated implementation, an inner surface of each flux choking feature 116 is separated from rotor 102 by only the air gap (“g”) between the rotor 102 and the stator 104. In a typical implementation, there is a flux choking feature 116 across every pair of adjacent teeth 110 in the stator 104 of a machine 100. Moreover, every flux choking feature 116 is substantially identical in size and shape as the other flux choking features 116 in the machine 100. Typically, there is one and only one flux choking feature between each pair of adjacent teeth on the stator.

In a typical implementation, each flux choking feature can be characterized by the following equation:

$$d = \frac{0.25 f [ a - b ]}{[ g + h ]} [ \frac{Brh}{B} - \frac{L}{{μ}_{R}} ] ,$$

where:
d=the maximum thickness of that flux choking feature in a radial direction,
g=the thickness of an air gap between the rotor and the stator,
h=the thickness of each one of the magnets in a radial direction,
L=the length of that flux choking feature along a circumferential path,
f=the diameter of the rotor,
a=the slot angle=360 degrees/a number of slots (N),
b=the pole angle=360 degrees/a number of poles (M),
μᵣ=the relative permeability value of the stator's lamination material at a saturation flux density,
B=the saturation flux density in the flux choking feature during operation of the dynamoelectric machine, and
Br=the remanence flux density of each magnet.

Several of these variables (e.g., d, g, h, L, f, a, and b) are represented in the exemplary implementation shown in FIG. 1. In a typical implementation, and as shown in FIG. 1, for example, the thickness (d) of the flux choking feature 116 in the radial direction is constant, or at least substantially constant, across an entirety, or at least a substantial entirety, of the length (L) of the flux choking feature 116.

Moreover, in some implementations, the machine may have a high pole count rotor with a relatively small slot count stator. In general, the high pole count may help with overall machine performance, whereas the low slot count may facilitate manufacturing and winding in particular, all while increasing overall torque density of the machine.

In some implementations, it is desirable for tooth width (at an inner edge of the tooth) in the stator to be less than the arc of a single magnet in the rotor. This helps reduce the likelihood that any magnetic flux might bypass the teeth.

In some implementations, it is desirable for the thickness “d” of each flux choking feature, be such that flux density in that section will exceed the material's saturation point with as little field as possible. Thus the “d” may be dependent, in part, on the machine's air gap and the material's magnetic permeability. For common motor materials “d” may be less than 0.2 mm. For soft magnetic materials this number might be different. In some implementations, the length of the choking feature may be dependent on the spacing between the stator teeth (which may be determined by the pole arc (b)).

In the illustrated implementation, in addition to the teeth 110 and the flux choking features 116, the stator 104 has a cylindrical outer portion 118 that surrounds and is in physical contact with an outer perimeter of the teeth 110 of the stator 104. In some implementations, the cylindrical outer portion 118 is keyed to or otherwise physically coupled to or near the outer perimeter of the teeth 110. In some implementations, the entire stator core, including the teeth 110, the flux choking features 116, and the cylindrical outer portion 118, are all the same type of material (e.g., stacked steel laminations, soft magnetic material either as a monolithic stator or in conjunction with laminated steel, etc.). In a typical implementation, the magnetic path through the machine is three dimensional and the stator is constructed of stacked laminated steel pieces.

In a typical implementation, the machine 100 includes a housing (not shown in FIG. 1) to contain the stator 104 and the rotor 102. The housing can, of course, be any size. However, in some implementations, the housing can have an outer diameter that is 15 millimeters to 44 millimeters.

The magnetic structure that creates the poles 114 on the rotor 102 can be virtually any kind of magnet or magnets (e.g., one or more permanent magnets or electromagnets). Generally speaking, a permanent magnet is an object made from a material that is magnetized and creates its own persistent magnetic field. An electromagnet is a type of magnet in which the magnetic field is produced by an electric current. The magnetic field disappears when the electric current is turned off. In the illustrated implementation the magnetic structure is a single permanent magnet with multiple poles.

The speed at which the rotor will spin may depend, for example, on the specific design and intended application of the machine 100. For example, in different implementations, the rotor may spins at a speed that can be anywhere from 500 to 20,000 revolutions per minute. More typically, however, the rotor will spin at a speed that is between 6,000 and 10,000 revolutions per minute.

The torque density that the machine 100 produces also may depend, for example, of the specific design and intended application of the machine 100. For example, in some implementations, the machine 100 may be configured to produce, while operating, a torque density of at least 0.00008 milliNewton-meters per cubic millimeter (mNm/mm̂3) per millimeter of stack length.

As mentioned above, the machine 100 typically has slot to pole ratio less than or equal to 0.83. In various implementations, the machine 100 may have 3 slots and 4 poles, 6 slots and 8 poles, 9 slots and 12 poles, 9 slots and 14 poles, 12 slots and 16 poles, 15 slots and 18 poles, 15 slots and 20 poles, or 12 slots and 14 poles.

The stator, as shown in the illustrated implementation, has a closed slot type of construction.

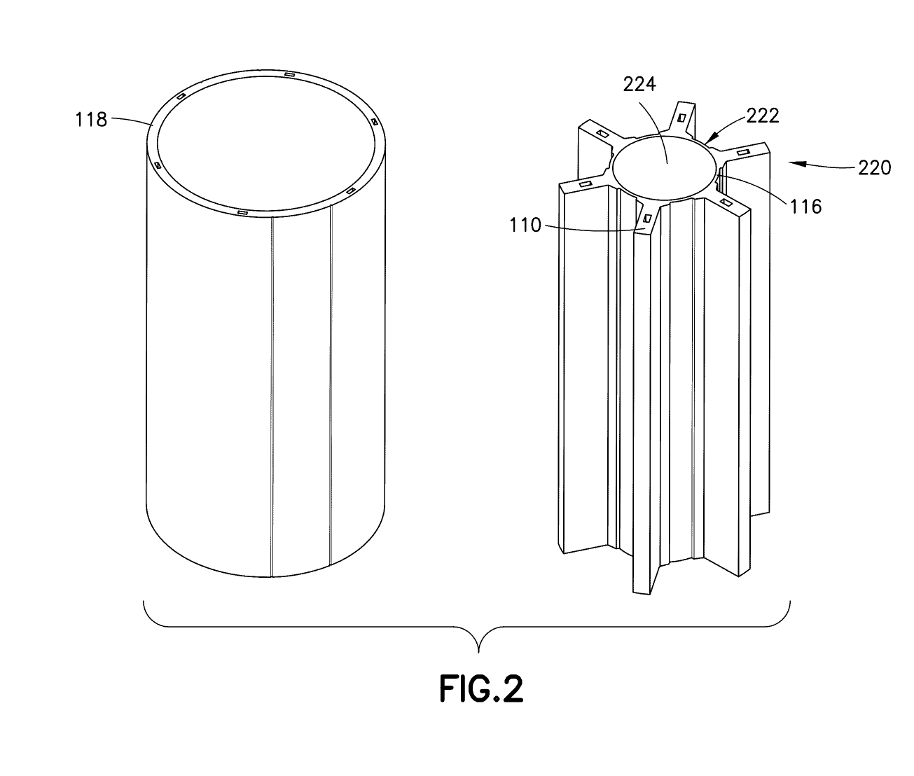

FIG. 2 shows an exemplary implementation of pieces that may be used to form part of a stator, such as the stator 104 in the machine 100 of FIG. 1. More particularly, the illustrated pieces include an exemplary cylindrical outer portion 118 and an exemplary insert 220 that can fit within the cylindrical outer portion 118.

The cylindrical outer portion 118 forms an elongate, hollow, cylindrical tube. The tube is sized to define an interior space that is large enough to snugly accommodate the insert 220. In various implementations, the cylindrical outer portion 118 includes stacked steel laminations, as shown, or soft magnetic material in either a monolithic form or in conjunction with laminated steel.

The insert 220 has an elongate body with an inner portion 222 that defines an interior cylindrical opening 224. The interior cylindrical opening 224 is sized and shaped to accommodate a substantially cylindrical rotor, such as the rotor 102 shown in FIG. 1, with a small air gap there between.

Six teeth 110 extend in a radially outward direction from an outer surface of the inner portion 222 of the insert 220. The inner portion 222 also defines a flux choking features 116 between each respective pair of adjacent teeth 110. In various implementations, the insert 220 includes stacked steel laminations, as shown, or soft magnetic material in either a monolithic form or in conjunction with laminated steel.

In a typical implementation, such as the one shown in FIG. 2, the cylindrical outer portion 118 is substantially the same length as the insert 220. Therefore, when the insert 220 is placed inside the cylindrical outer portion 118, it extends substantially end-to-end inside the cylindrical outer portion 118, without extending at all beyond the ends of the cylindrical outer portion 118.

In a typical implementation, the cylindrical outer portion 118 and the insert 220 are dimensioned so that, when the insert 220 is positioned inside the cylindrical outer portion 118, the outer edges of the teeth 110 of the insert 220 physically contact an inner surface of the cylindrical outer portion 118. In this way, the resulting assembly defines six slots, such as the slots 112 in FIG. 1, (i.e., a slot between each pair of teeth) to accommodate electrically conductive windings (not shown).

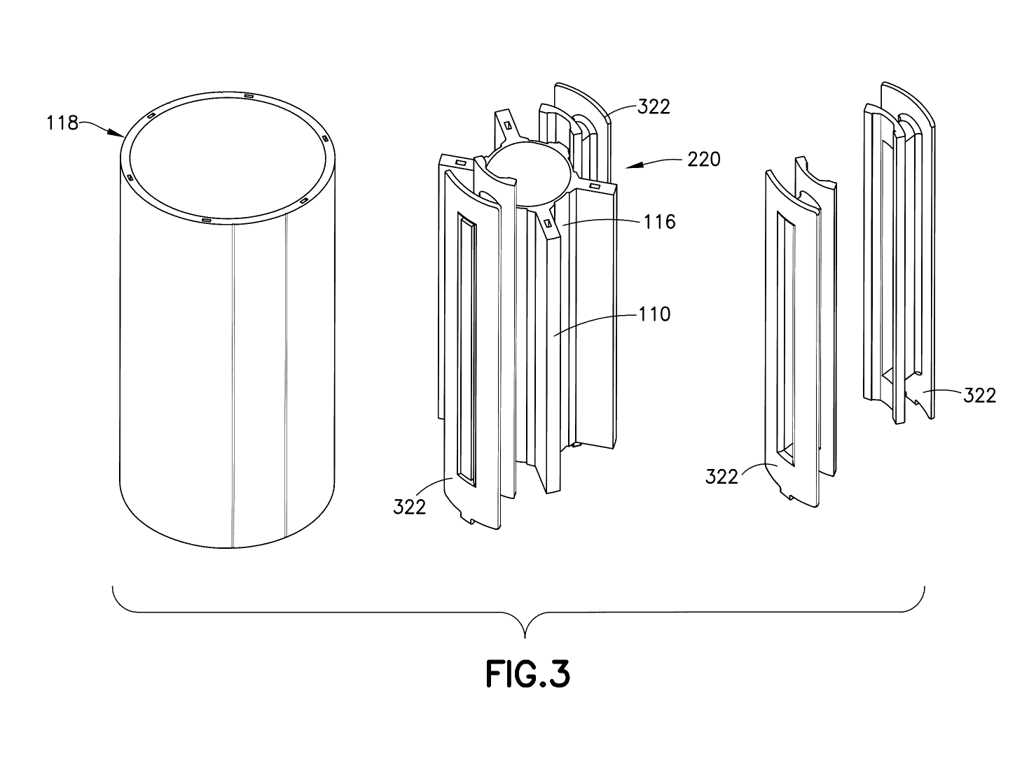

FIG. 3 shows the cylindrical outer portion 118 and the insert 220 of FIG. 2 along with a plurality of bobbins 322, upon which the stator's electrically conductive windings can be wound.

Each bobbin 322 is configured to be fastened onto a corresponding one of the teeth 110 on the inset 220 of the stator and to support a coil wound onto it. In this regard, each bobbin 322 has an inner flange, an outer flange and a spindle that extends between the inner flange and outer flange. In a typical implementation, the coil gets wrapped around the spindle.

There is also an opening that extends through each bobbin 322 in an axially outward direction when the bobbin is coupled to one of the teeth 110 of the insert 220. In this regard, each opening extends through the inner flange, the spindle and the outer flange of a corresponding one of the bobbins 322. Each opening is configured to accommodate one of the teeth 110 on the insert 220.

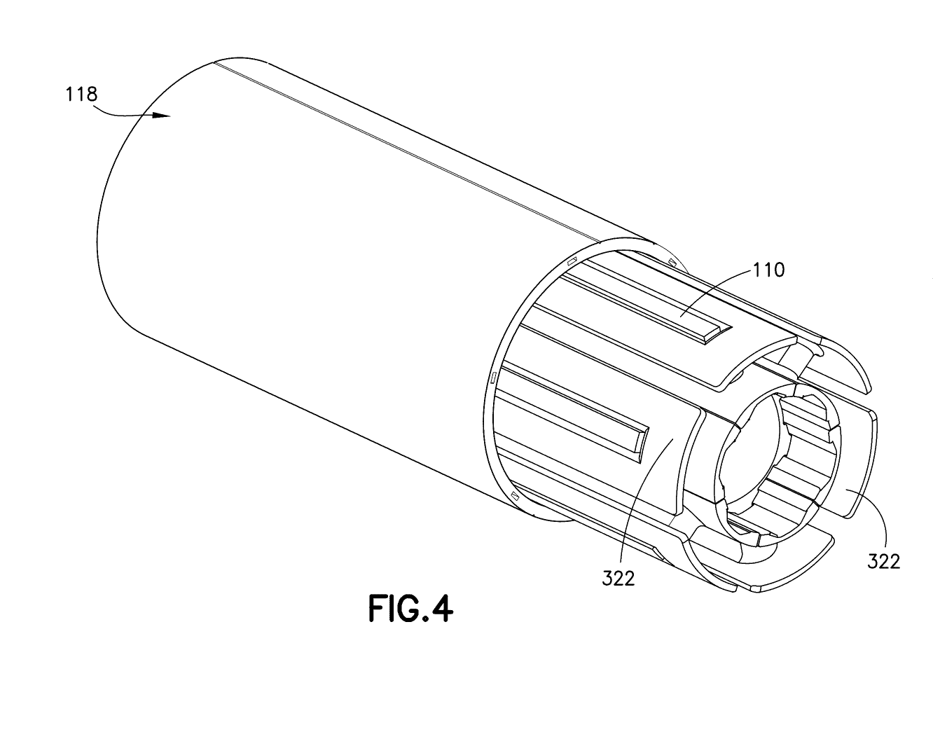

FIG. 4 shows an example of a partially assembled stator assembly that includes an insert 220, with six bobbins 322 coupled to it and partially inserted into an outer cylindrical portion 118 of the stator. It is clear from the illustrated example that, when assembled, an outer edge of each tooth 110 of the insert 220 physically contacts an inner surface of the outer cylindrical portion 118.

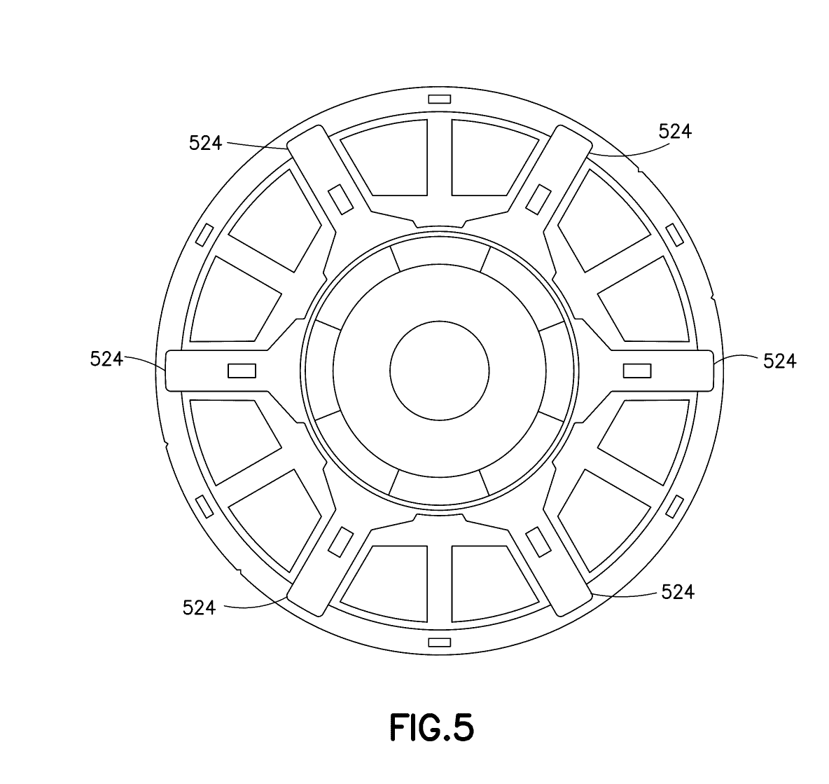

In some implementations, such as the one represented in the schematic diagram of FIG. 5, the machine may include a keying arrangement to fix the position of the insert 220 relative to the outer cylindrical portion 118.

More particularly, in the illustrated example, the keying arrangement includes notches 524 formed in the inner surface of the outer cylindrical portion 118 that are configured to receive and hold the outer ends of the teeth 110. This, of course, represents only one particular example of a keying arrangement. A variety of other options are possible as well.

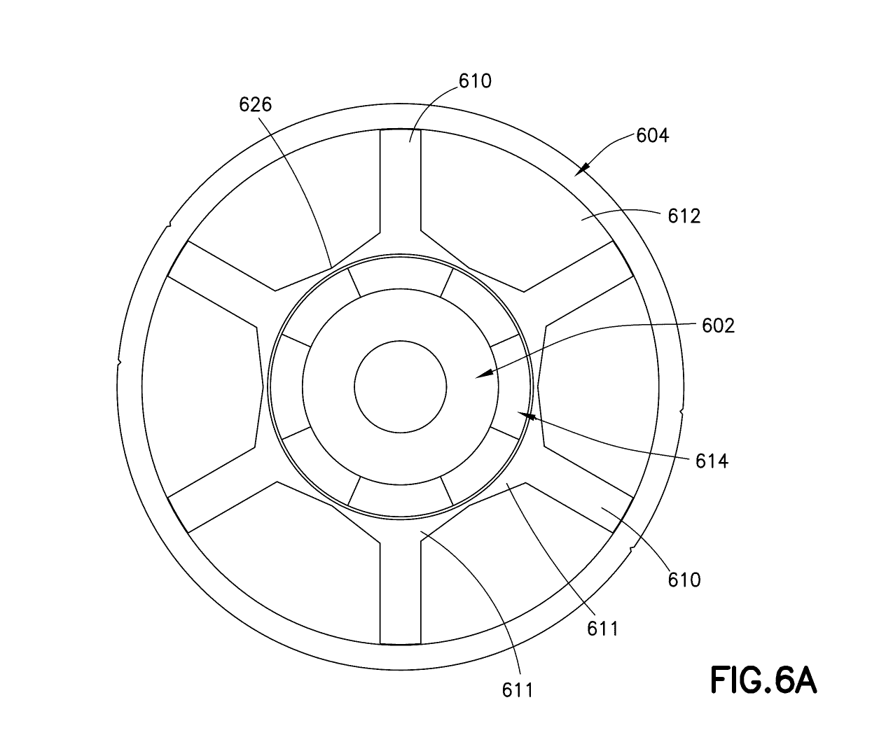

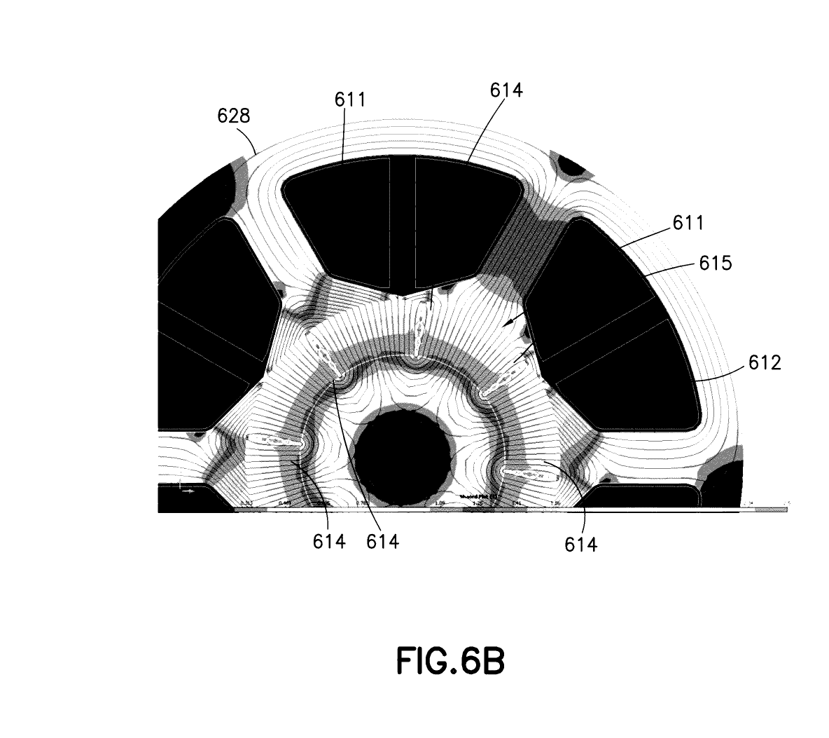

FIG. 6A shows an exemplary implementation of an electrical machine 600 that is similar to the machine 100 in FIG. 1, for example, in that it includes a rotor 602 and a stator 604. Moreover, the stator 604 in machine 600 has a closed slot configuration.

The stator 604 of the machine 600 in FIG. 6A, however, does not include a flux choking feature like the flux choking feature 116 in the machine 100 of FIG. 1. Instead, there are flared portions 611 at the inner part of each tooth 610, each of which extends substantially to a center of an adjacent slot 612 next to that tooth 610. Adjacent flared portions 611, extending from adjacent teeth 610 form a substantially “v”-shaped inner surface of a corresponding slot, coming to a single point 626 at or near the inner, center of the slot.

The rotor 602 of the illustrated machine 600 has a plurality of magnetic poles 614 around its perimeter.

In the illustrated implementation, there are eight poles and six slots 612. With the arrangement of components provided, the inner flared edge of each tooth is wider than each magnet. That is, each inner flared edge extends across a greater extent of the circumferential path it follows, than the extent of the circumferential path that an outer edge of each magnetic pole follows.

FIG. 6B is a topographical-style drawing showing magnetic flux distribution in machine 600 when it is operating.

Each magnetic pole 614 in the illustrated machine is shown as producing a magnetic field. Moreover, each line 628 that is transposed over the outline of the machine 600 in FIG. 6B represents a collection of points in the machine being exposed to a relatively equal magnetic field strength.

It is generally desirable that as much of the magnetic flux generated by the magnets be directed into the teeth of the stator 604 to help move the rotor 602 relative to the stator. However, it is clear from the illustrated figure that a portion of the magnetic fields that are generated by the magnets 614 actually bypass the teeth 610. Generally speaking, reducing the amount of magnetic flux that bypasses the teeth can increase overall machine performance. The flux choking features disclosed herein (e.g., 116 in the machine of FIG. 1), among other things, help reduce the amount of magnetic flux bypassing the teeth in a machine and, thereby, increase machine performance, including, for example, available torque density.

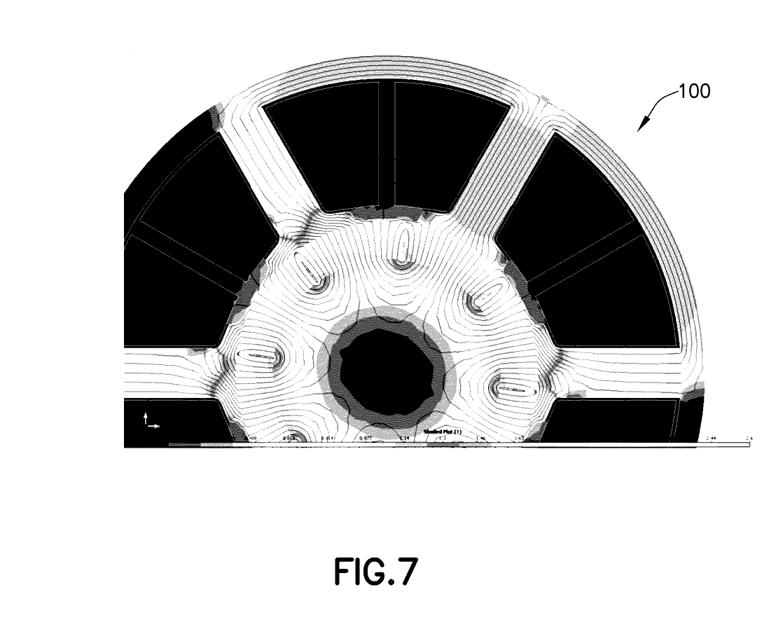

FIG. 7 is a topographical-style drawing showing magnetic flux distribution in machine (similar to machine 100 of FIG. 1, with flux choking features 116), when it is operating. From the illustrated implementation, it is clear that the relatively small thickness of each flux choking feature 116 in the radial direction and the length of each flux choking feature along a circumferential path help minimize the amount of magnetic flux that can bypass the teeth 110 of the illustrated machine.

Thus, a method of enhancing torque density in a machine (e.g., a dynamoelectric machine) has been described. One exemplary type of machine this method may apply to generally includes a stator with multiple teeth that define slots between the teeth to accommodate windings, a rotor inside the stator with multiple alternating polarity permanent magnetic poles, where the poles at the rotor outnumber the slots at the stator.

In a typical implementation, the method includes providing multiple flux choking features in the machine, where each flux choking feature extends circumferentially between one pair of adjacent teeth on the stator at an inner edge of the stator. Moreover, each flux choking feature is configured to prevent magnetic flux from the magnets from bypassing the teeth of the stator.

Moreover, a typical flux choking feature is configured with characteristics defined by:

$$d = \frac{0.25 f [ a - b ]}{[ g + h ]} [ \frac{Brh}{B} - \frac{L}{{μ}_{R}} ] ,$$

where:
d=the maximum thickness of the flux choking feature in a radial direction,
g=the thickness of an air gap between the rotor and the stator,
h=the thickness of one of the magnets in a radial direction,
L=the length of the flux choking feature circumferentially,
f=the diameter of the rotor,
a=the slot angle=360 degrees/a number of slots (N),
b=the pole angle=360 degrees/a number of poles (M),
μᵣ=the relative permeability value of the stator's lamination material at a saturation flux density,
B=the saturation flux density inside the flux choking feature, and
Br=the remanence flux density of each magnet.

In configuring each flux choking feature, the thickness (d) of the flux choking feature in the radial direction is made constant across an entirety of the length (L) of the flux choking feature along a circumferential path.

In a typical implementation, the method also include placing the stator and the rotor inside a housing, where the housing has an outer diameter that is less than or equal to 44 millimeters and greater than or equal to 15 millimeters. Furthermore, the method typically includes positioning a cylindrical outer portion (e.g., a back iron) to surround and be in physical contact with an outer perimeter of the teeth of the stator.

The machine can be operated such that the rotor spins, for example, between 500 and 20,000 revolutions per minute, and such that the machine produces, for example, a torque density of at least 0.00008 mNm/mm̂3 per mm stack length.

Moreover, the slot to pole ratio is generally made to be less than or equal to 0.83.

A number of embodiments of the invention have been described. Nevertheless, it will be understood that various modifications may be made without departing from the spirit and scope of the invention.

For example, a wide range of materials and/or manufacturing techniques can be used to manufacture the different parts or components of a particular machine. The specific shapes and relative sizes of the different parts or components of a machine can differ from model to model.

In some implementations, the machine need not have bobbins for the electrically conductive windings. In those implementations, the electrically conductive windings for the stator may be wound directly onto the teeth of the stator without using bobbins.

Although the equation for “d” provided herein is described as representing a “maximum” thickness of the flux choking feature in a radial direction, it should be understood that this “maximum” is only a “maximum” for purposes of ensuring a high degree of effectiveness in the functionality of the flux choking feature. In some implementations, the flux choking feature can have a greater thickness than that. Meanwhile, at the other end of the dimensional spectrum, the “minimum” thickness of the flux choking feature may be quite thin—typically limited, for example, only by mechanical considerations.

It should be understood that any use of relative terminology, such as “upper”, “lower”, “above”, “below”, “front”, “rear,” etc. herein is solely for purposes of clarity and to describe particular implementations. Unless otherwise indicated, these relative terms are not intended to limit the scope of what is described here or to require particular positions and/or orientations. Accordingly, such relative terminology should not be construed to limit the scope of the present application.

Other implementations are within the scope of the claims.

What is claimed is:

1. An electrical machine comprising:
a stator with a plurality of teeth that define a plurality of slots between the teeth to accommodate electrically conductive windings;
a rotor inside the stator, wherein the rotor has a plurality of alternating polarity magnetic poles;
wherein the poles at the rotor outnumber the slots at the stator; and
a plurality of flux choking features, wherein each flux choking feature extends along a circumferential path between one pair of adjacent teeth on the stator at an inner edge of the stator.

2. The machine of claim 1, wherein each flux choking feature is configured to prevent magnetic flux from the magnetic poles from bypassing the teeth of the stator during operation of the dynamoelectric machine.

3. The machine of claim 2, wherein each flux choking feature has a length (L) and thickness (d) that is related to other machine characteristics by:
$$d = \frac{0.25 f [ a - b ]}{[ g + h ]} [ \frac{Brh}{B} - \frac{L}{{μ}_{R}} ] ,$$
where:
d=the maximum thickness of that flux choking feature in a radial direction,
g=the thickness of an air gap between the rotor and the stator,
h=the thickness of each one of the magnets in a radial direction,
L=the length of that flux choking feature along a circumferential path,
f=the diameter of the rotor,
a=the slot angle=360 degrees/a number of slots (N),
b=the pole angle=360 degrees/a number of poles (M),
μᵣ=the relative permeability value of the stator's lamination material at a saturation flux density,
B=the saturation flux density in the flux choking feature during operation of the dynamoelectric machine, and
Br=the remanence flux density of each magnet.

4. The machine of claim 3, wherein the thickness (d) of the flux choking feature in the radial direction is constant across an entirety of the length (L) of the flux choking feature.

5. The machine of claim 1, further comprising:
a housing that contains the stator and the rotor,
wherein the housing has an outer diameter that is less than or equal to 44 millimeters.

6. The machine of claim 5, wherein the outer diameter of the housing is greater than or equal to 15 millimeters.

7. The machine of claim 1, wherein the stator further comprises:
a cylindrical outer portion that surrounds and is in physical contact with and/or keyed to an outer perimeter of the teeth of the stator.

8. The machine of claim 7, wherein the teeth, the flux choking features, and the cylindrical outer portion are all the same type of material.

9. The machine of claim 1, wherein each tooth has a flared portion at inner edge, and
wherein each of the flux choking features extends from an inner edge of the flared portion of one tooth to an inner edge of the flared portion of another tooth.

10. The machine of claim 1, further comprising one or more magnetic structures that produce the magnetic poles, wherein each of the one or more magnetic structures is a permanent magnet.

11. The machine of claim 1, wherein the rotor comprises electromagnetic field sources that comprise electromagnets or permanent magnets.

12. The machine of claim 1 configured such that, during operation, the rotor spins between 500 and 20,000 revolutions per minute.

13. The machine of claim 1 configured to produce, while operating, a torque density of at least 0.00008 mNm/mm̂3 per mm stack length.

14. The machine of claim 1, wherein a slot to pole ratio is less than or equal to 0.83.

15. The machine of claim 1, comprising:
3 slots and 4 poles, 6 slots and 8 poles, 9 slots and 12 poles, 9 slots and 14 poles, 12 slots and 16 poles, 15 slots and 18 poles, 15 slots and 20 poles, or 12 slots and 14 poles.

16. The machine of claim 1, wherein one and only one of the flux choking features is between each pair of adjacent teeth on the stator.

17. The machine of claim 1, wherein the stator is constructed of stacked steel laminations, or soft magnetic material either as a monolithic stator or in conjunction with laminated steel.

18. The machine of claim 1, wherein a magnetic path through the machine is three dimensional and the stator is constructed of stacked laminated steel.

19. The machine of claim 1, wherein the stator is of closed slot construction.

20. A method of enhancing torque density in a dynamoelectric machine,
wherein the dynamoelectric machine comprises a stator with a plurality of teeth that define a plurality of slots between the teeth to accommodate windings, a rotor inside the stator with a plurality of alternating magnetic poles, wherein the magnetic poles at the rotor outnumber the slots at the stator,
the method comprising:
providing a plurality of flux choking features, wherein each flux choking feature extends circumferentially between one pair of adjacent teeth on the stator at an inner edge of the stator,
wherein the flux choking feature is configured to prevent magnetic flux from the magnetic poles from bypassing the teeth of the stator.

21. The method of claim 20, further comprising:
configuring the flux choking feature to have a length (L) and a thickness (d) defined by:
$$d = \frac{0.25 f [ a - b ]}{[ g + h ]} [ \frac{Brh}{B} - \frac{L}{{μ}_{R}} ] ,$$
where:
d=the maximum thickness of the flux choking feature in a radial direction,
g=the thickness of an air gap between the rotor and the stator,
h=the thickness of one of the magnets in a radial direction,
L=the length of the flux choking feature circumferentially,
f=the diameter of the rotor,
a=the slot angle=360 degrees/a number of slots (N),
b=the pole angle=360 degrees/a number of poles (M),
μᵣ=the relative permeability value of the stator's lamination material at a saturation flux density,
B=the saturation flux density inside the flux choking feature, and
Br=the remanence flux density of each magnet.

22. The method of claim 21, further comprising:
configuring the flux choking feature so that the thickness (d) of the flux choking feature in the radial direction is constant across an entirety of the length (L) of the flux choking feature along a circumferential path.

23. The method of claim 22, further comprising:
placing the stator and the rotor inside a housing,
wherein the housing has an outer diameter that is less than or equal to 44 millimeters and greater than or equal to 15 millimeters.

24. The method of claim 23, further comprising:
positioning a cylindrical outer portion to surround and be in physical contact with an outer perimeter of the teeth of the stator.

25. The method of claim 20, further comprising:
operating the dynamoelectric machine such that the rotor spins between 500 and 20,000 revolutions per minute, and such that the machine produces a torque or torque density of at least 0.00008 mNm/mm̂3 per mm stack length.

26. The method of claim 20, further comprising:
providing a slot to pole ratio of less than or equal to 0.83.
